(19) United States
(12) Patent Application Publication
(10) Pub. No.: US 2006/0277093 A1
(43) Pub. Date: Dec. 7, 2006

(54) System and method of automatic polling

(76) Inventors: William Barnhouse III, La Union, NM (US); Craig Fortune, El Paso, TX (US); Russell S. Autry, Santa Teresa, NM (US); Jesse A. Allen, El Paso, TX (US)

Correspondence Address: R WAYNE PRITCHARD, 863 VIA ALTA LANE, EL PASO, TX, 79912, US

(21) Appl. No.: 11/440,100

(22) Filed: May 25, 2006

Related U.S. Application Data
(60) Provisional application No. 60/685,005, filed on May 26, 2005.

(51) Int. Cl. G06F 17/30

(52) U.S. Cl. 705/10

(57) ABSTRACT

A system and method of automatic polling.

### PRIORITY

Applicants claim the benefits of the filing date for Provisional Application, Ser. No. 60/685,005, filed May 26, 2005.

### BACKGROUND OF THE INVENTION

1. Field of the Invention

This invention relates to a system and method of automatic polling.

2. Description of the Prior Art

Many examples exist in the prior art for automatic telephone dialing. Besides examples disclosed in U.S. patents such as U.S. Pat. No. 5,799,077; U.S. Pat. No. 4,054,756; U.S. Pat. No. 4,761,807; and U.S. Pat. No. 5,058,152, an entire industry (the telemarketing industry) has prospered from the ability to automatically dial and receive large volumes of telephone calls. Telemarketing systems such as those disclosed by U.S. Pat. No. 4,160,125, are today widely used and commonly accepted. These systems which provide for automatic telephone dialing, however, do not pre-select participants based upon relevant demographic or biographic information nor do such systems allow for the retention of opinions for the purposes of polling. Additionally, while the size and expense of automatic dialing systems have decreased since introduction into the market place, they remain a costly investment both in terms of dollars and storage space.

An amusing statement of the times we live in, is that we are often impatient for the microwave to finish cooking. We live in a society where results are needed immediately and decisions often made on the basis of sound bites we see on line via the Internet. No where is this more apparent than in the modern era of political elections. In a national elections such as the one for President, the voting electorate is often swayed by daily, if not hourly, economic news or, as in the case of the 2004 Presidential election, daily reports on the war in Iraq. Elections may be decided on small voting margins therefore a need exists for candidates to know the electoral mind-set on an immediate and instantaneous basis. National organizations such as the Democratic and Republican National Committees, possess the financial resources to muster the machinery and personnel to sample electoral opinion as often and as immediate as needed. For the most part, entities such as the Republican and Democratic parties, employ the use of systems such as the automatic dialing systems described above combined with the man power necessary to search accessible databases or to call on the electorate door to door. On a more local basis such as statewide and/or city elections, candidates do not have either the time nor the money to conduct the expensive, elaborate polling necessary to determine election strategy. State wide candidates typically do not have the financial resources to lease or purchase the automatic dialing systems necessary to conduct efficient polling; they do not have the monies to invest in a means to search/retrieve information from existing databases; and they do not possess the man power to sample the electorate on a door to door basis. While much of what has been discussed above deals with polling techniques used in connection with elections, assuming an infinite budget were available, one could use the same basic methodology to determine opinions regarding any subject such as which newscast is best or what baseball team should be courted for the new expansion athletic complex.

Automatic polling systems have been attempted before. Automatic polling systems such as those disclosed by U.S. Pat. Nos. 4,922,520 and 4,438,296 have existed in the market for at least 20 years. The emphasis of such patents, however, were on the mechanics of the placing the actual telephone call such as in U.S. Pat. No. 4,438,296 (which provides for a multi-message equipment capability as well as establishing modes of operation to insure that each telephone number contacted is in fact answered), or the mechanics of retaining the information received as a result of such call such as in U.S. Pat. No. 4,922,520. Neither of the afore mentioned patents attempted to pre-select participants based upon relevant geographic or biographic information and both disclose relatively expensive, complicated systems.

In order to make automatic polling systems more efficient, attempts have been made to marry to configuration of automatic dialing machines to a method of pre-selecting participants based upon relevant demographic information. For example, in U.S. Pat. No. 5,559,867, a database relates telephone numbers to a particular geographical area and then uses such information to pinpoint the appropriate geographical area to be contacted concerning a particular weather related emergency. The foregoing patent does not, however, target the pre-selected individuals with specific questions designed to elicit opinions. Furthermore, the foregoing patent does not disclose a system designed for access by the population at large through convenient means such as a computer or via the Internet.

In addition to those inventions disclosed by U.S. patents, companies such as Blaemire, The Clinton Group, Votes4U.com, Aristotle, The Tyson Management Group, and Leads & Lists, Inc., in one shape or another, employ various different methods to conduct automatic polling. None of the foregoing companies, however, offer the unique and novel methodology of the present invention described below. For example, Blaemire is not a one stop shop and does not provide an economically feasible method for local style elections. Similarly, unlike the present invention, Lead & Lists appears to only provide voter lists.

In the modern world of the need for instantaneous data, a need exists for an inexpensive, simple, method to allow polling (determining opinions). As evidence by the U.S. patents issued in this field, no one, until now, has come up with a methodology that makes polling accessible to everyone.

### SUMMARY OF THE INVENTION

It is, therefore, an object of the present invention to provide a system and method of automatic polling that can be done quickly, affordably, and conveniently. In essence, this invention provides for a one stop shop for all a user's polling and/or opinion determination needs. Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is an illustration of methods of the current invention applied in general.

FIG. 2 illustrates the methodology of the current invention applied specifically to an election contest.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as the basis for the claims and as a basis for teaching one skilled in the art how to make and/or use the invention.

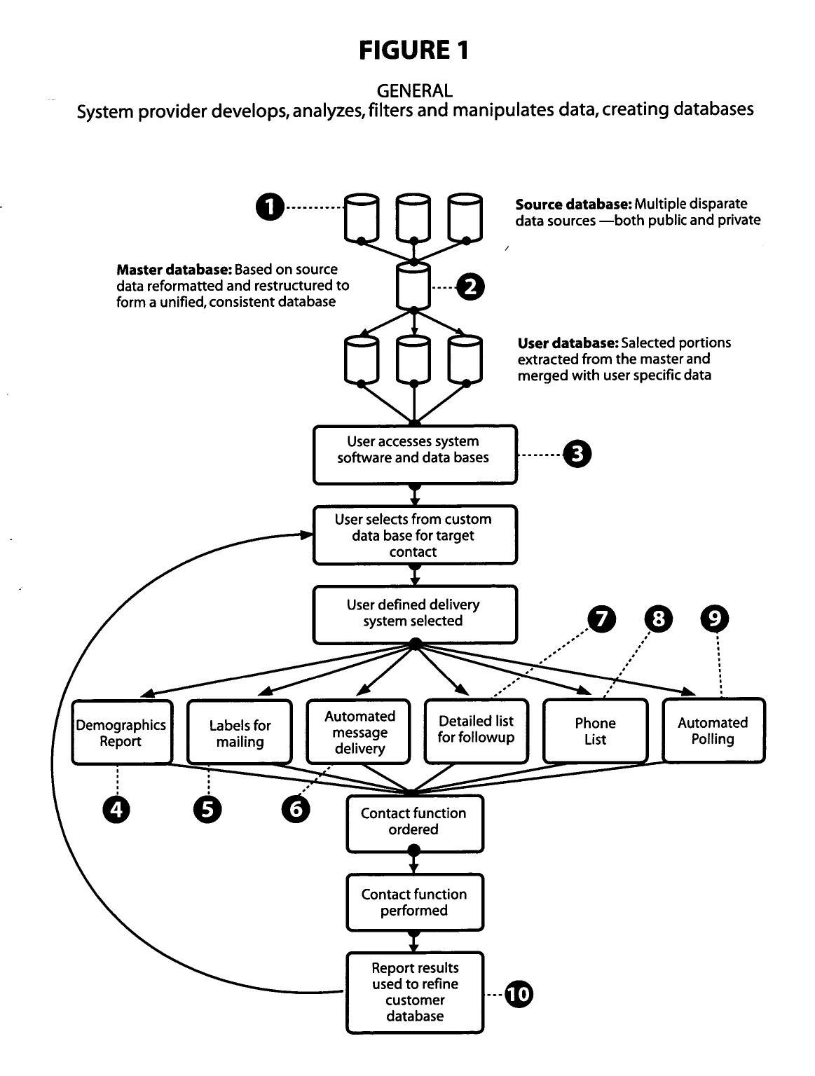

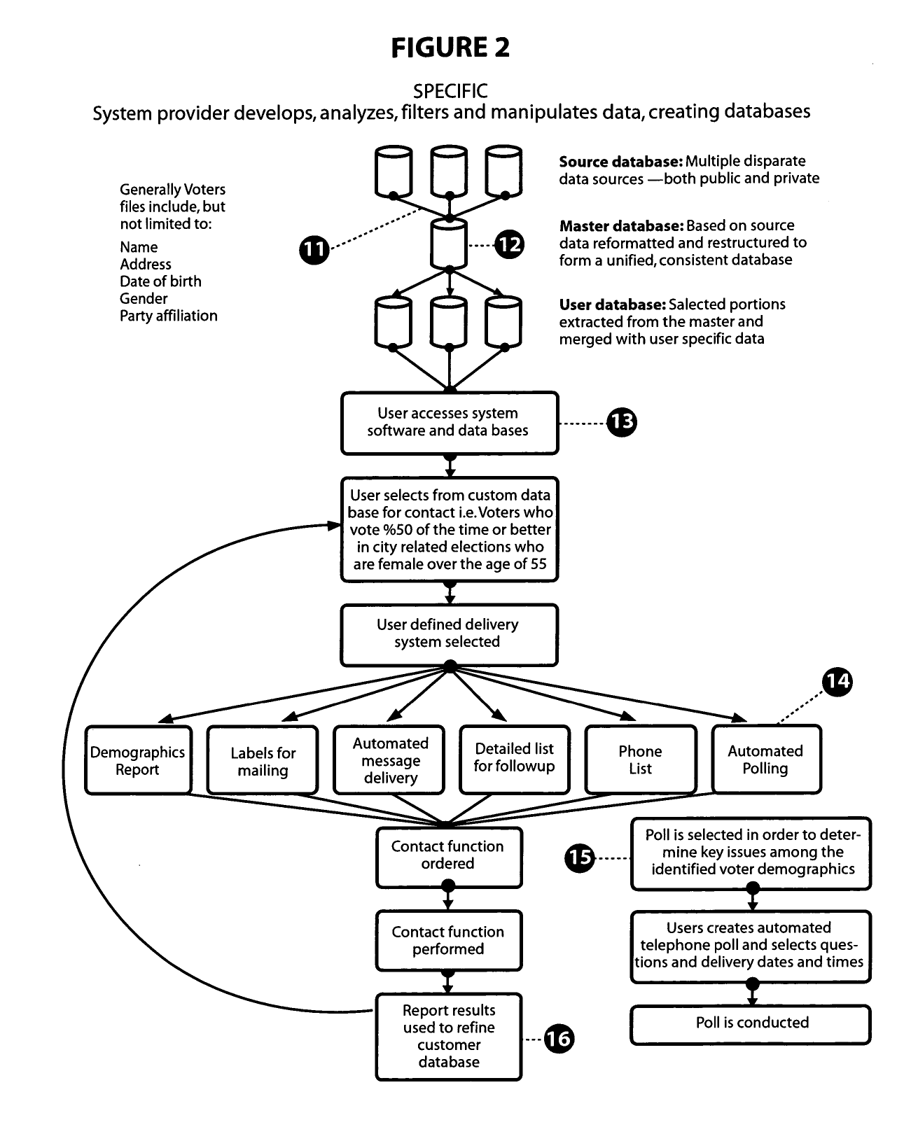

Shown in FIG. 1 is a depiction of the steps employed in the method disclosed herein. While in the past opinion/election polls including the method of determining who would be polled would have been done mechanically, i.e., by humans, the present invention uses computer programs to minimize the time and effort necessary to perform the required tasks. From source databases [1], which can be both private or public, biographical and demographical information is gathered and stored in a unified master database [2]. A user accessing the invention disclosed herein, customizes the data retrieved from the master database [2] by inputting the appropriate selection criteria [3]. For example, the user will provide information necessary to determine the scope of the opinion or poll to be conducted such as the geographical area to be sampled. In the election context, shown in FIG. 2, the foregoing information will be sufficient to enable the present invention to identify relevant search criteria such as voting age, most recent election in which the participant voted, and whether the participant voted Republican or Democratic. Once the data to be retrieved from the master database [2] has been customized, the user defines the delivery system he or she desires such as a demographic report [4], a mailing list [5], automated message delivery [6], a follow up list [7], a telephone listing [8] or automated polling [9]. Once the delivery system has been selected, the desired function is performed and a report specific to the inputted criteria is generated and returned to the user [10].

For example, as shown in FIG. 2, in connection with polling regarding an election, information is retrieved from public and private voter files, voter history and telephone numbers [11]. Once the foregoing information is retrieved, it is formatted into a unified voter database [12]. Using the unified voter database [12], a user customizes the database by inputting relevant search criteria such as the election race of interest and what information regarding the electorate in which he or she is interested. [13]. As in the general example detailed above, the user then selects the delivery system desired. If a user selects automated polling [14], automatic telephone calling devices are used to send telephone calls to each participant which when answered, provide the participants with pre-recorded questions [15] to be answered. The poll questions can also be sent to poll participants via email. The answers to the pre-recorded questions are then recorded. Computer programs can be used to increase the efficiency in which the calls or emails are placed. The pre-recorded questions as well as the responses to such questions can be recorded on any conventional means although the most efficient and economic way is to record the foregoing is in digital format directly into a computer. The results of the polling are then analyzed either using humans or via computer programs to determine voting tendencies, trends and opinions. A report [16] for the foregoing is then provided to the requesting party either through conventional means, i.e. paper, although email or access through the Internet is the most economical and quickest means.

Many variations can exists for the system disclosed herein. For examples, instead of conducting a poll for an election, an automobile dealership can employ the same method to determine opinions regarding the services it offers. Additionally, news stations or news papers can use the method to determine audience opinions. While the preferred embodiments have been shown and described, it will be understood that there is no intent to limit the invention by such disclosure, but rather, is intended to cover all modifications and alternate constructions falling within the spirit and scope of the invention as defined in the appended claims.

1. A system and method of conducting automatic polling comprising the steps of:
A. Receiving a polling request;
B. Determining the relevant scope of the poll;
C. Determining the desired characteristics of the participants in the poll;
E. Searching databases to determine the identify of the desired participants;
F. Determining the questions to be asked of poll participants;
G. Contacting each poll participants with pre-recorded poll questions;
H. Recording the responses to poll questions;
I. Generating a poll report;
J. Furnishing poll report to requesting party.

2. The system and method of claim 1 wherein the polling request is received via a web page on the Internet

3. The system and method of claim 1 wherein the databases to be searched are composed of relevant biographical and demographical voter information.

4. The system and method of claim 1 wherein the poll participants are contacted using automatic dialing equipment.

5. The system and method of claim 1 wherein the poll report is computer generated.

6. The system and method of claim 5 wherein the poll report is accessed through an Internet web page.

7. A system and method of conducting automatic polling comprising the steps of:
A. Accessing biographical and demographical databases;
B. Compiling from the accessed databases voter statistics for local and state wide political races;
C. Receiving a polling request;
D. Determining the relevant scope of the poll;
E. Determining the desired characteristics of the participants in the poll;
F. Searching databases to determine the identify of the desired participants;
G. Determining the questions to be asked of poll participants;
H. Contacting each poll participants with pre-recorded poll questions;
I. Recording the responses to poll questions;
J. Generating a poll report;
K. Furnishing poll report to requesting party.

8. The system and method of claim 7 wherein the polling request is received via a web page on the Internet

9. The system and method of claim 7 wherein the databases to be searched are composed of relevant biographical and demographical voter information.

10. The system and method of claim 7 wherein the poll participants are contacted using automatic dialing equipment.

11. The system and method of claim 7 wherein the poll report is computer generated.

12. The system and method of claim 11 wherein the poll report is accessed through an Internet web page.

13. The system and method of claim 7 wherein the databases are accessed electronically.

14. The system and method of claim 7 wherein the identity of the desired participants is done through electronically searching the compiled database using relevant search criteria.
